(19) United States
(12) Patent Application Publication
(10) Pub. No.: US 2016/0372755 A1
(43) Pub. Date: Dec. 22, 2016

(54) ELECTROCHEMICAL CELL AND METHOD FOR PRODUCING AN ELECTROCHEMICAL CELL

(71) Applicant: ROBERT BOSCH GMBH, Stuttgart (DE)

(72) Inventors: Ulrich SAUTER, Karlsruhe (DE); Marcus Wegner, Leonberg (DE); Joerg Thielen, Stuttgart (DE); Barbara Stiaszny, Leonberg (DE)

(73) Assignee: Robert Bosch GmbH, Stuttgart (DE)

(21) Appl. No.: 15/038,382

(22) PCT Filed: Oct. 23, 2014
(86) PCT No.: PCT/EP2014/072699

§ 371 Date: Aug. 23, 2016

(30) Foreign Application Priority Data
Nov. 27, 2013 (DE) 10 2013 224 302.2

(51) Int. Cl. H01M 4/62; H01M 10/058; H01M 10/0525

(52) U.S. Cl. CPC H01M 4/628; H01M 10/0525; H01M 4/622; H01M 10/058

(57) ABSTRACT

An electrochemical cell that includes a negative electrode, a positive electrode, a protective layer situated on the negative electrode, which separates the negative electrode from the positive electrode, and an electrolyte, the negative electrode at least partially including metallic lithium, and the protective layer situated on the negative electrode being formed of a composite material, including at least one first material and one second material. Also described is a corresponding method for manufacturing an electrochemical cell.

### FIELD OF THE INVENTION

The present invention relates to an electrochemical cell and to a method for manufacturing an electrochemical cell.

### BACKGROUND INFORMATION

Electrochemical cells, in particular lithium-based secondary batteries, are used as energy stores in mobile information devices, such as mobile telephones, in tools or in electrically operated automobiles and automobiles with hybrid drives due to their energy density and high capacity. Despite these very different fields of application of electrochemical cells, all cells used must meet similarly high requirements: which may be high specific capacity and specific energy density, which remains stable over a high number of charging and discharging cycles, at which may be low weight.

Particularly high specific energy densities for lithium-based batteries are achievable through the use of a lithium-metal anode. The use of a lithium-metal anode, however, is accompanied by quite significant problems. The irregular deposition and dissolution of lithium represents a big challenge. This results in the formation of dendrites (solidified, needle-shaped crystals), which, upon penetration of the separator and contact with the cathode, may result in a short circuit of the battery. Moreover, the electrolytes used are not stable with respect to lithium. As a result, a continuous decomposition of the electrolyte components during the battery operation takes place.

Patent document DE 10 2010 054 610 A1 discusses an electrochemical cell, including a negative electrode, a positive electrode, a separator separating the positive electrode from the negative electrode, and an electrolyte, the negative electrode including metallic lithium and being coated. The coating includes inorganic, ion-conducting material, which is configured as fibers or particles.

### SUMMARY OF THE INVENTION

The present invention provides an electrochemical cell, including a negative electrode, a positive electrode, a protective layer situated on the negative electrode, which separates the negative electrode from the positive electrode, and an electrolyte, the negative electrode at least partially including metallic lithium, and the protective layer situated on the negative electrode being formed of a composite material, including at least one first material and one second material.

The present invention furthermore creates a method for manufacturing an electrochemical cell, including a negative electrode, a positive electrode, a protective layer situated on the negative electrode, which separates the negative electrode from the positive electrode, and an electrolyte, the negative electrode at least partially including metallic lithium, and the protective layer situated on the negative electrode being formed of a composite material, including at least one first material and one second material. The method includes the steps described hereafter. The steps include removing material of the first material, filling the second material into spaces formed in the first material for forming the protective layer, and situating the protective layer on the negative electrode of the electrochemical cell.

One aspect of the present invention is to provide an improved electrochemical cell and an improved method for manufacturing an electrochemical cell, which suppresses the dendrite growth on a lithium-metal anode and prevents the contact of the lithium-metal anode with the electrolyte. As a result, the cycle resistance of an anode within a cell is improved. This is achieved by introducing a composite material on the anode or the negative electrode.

Advantageous specific embodiments and refinements are derived from the further descriptions herein as well as from the descriptions with reference to the figures.

It may be provided that the first material is formed by a lithium ion-conducting material and the second material is formed by a polymer, and the protective layer includes conduction paths, which are formed by material channels of the lithium ion-conducting material, the conduction paths being formed continuously in the vertical direction of the protective layer.

The composite material, which is flexible due to its composition, prevents the dendrite growth toward the positive electrode and increases the cycle stability of the cell. Due to its configuration, the number of interfaces within the flexible protective layer or the negative electrode and the protective layer and the electrolyte is reduced to a minimum, and thus also the internal resistance of the cell, which is closely tied to the complex transitions between multiple materials over multiple interfaces. Providing the conduction paths in the form of continuous, lithium ion-conducting material channels improves the conductivity by the protective layer compared to known, continuous, multi-layer protective layers.

It may be furthermore provided that the lithium ion-conducting material has a lattice-shaped structure, including a multitude of components situated essentially perpendicularly to the negative electrode, and at least one component situated essentially in parallel to the negative electrode, the spaces formed in the lithium ion-conducting material being filled with polymer. The lithium ion-conducting material having a lattice-shaped structure forms the skeleton of the protective layer. The spaces are filled with the polymer. As a result, the composite material gains flexibility and stability with respect to volume changes in the cell.

According to one further embodiment, it is provided that the conduction paths each have a rectangular or round cross section. In this way, a volume fraction of the polymer and of the lithium ion-conducting material may be specified.

According to one further exemplary embodiment, it is provided that an intermediate layer is situated between the negative electrode and the lithium ion-conducting material of the protective layer. Some of the lithium ion-conducting materials are not stable in direct contact with metallic electrodes, such as in particular lithium. Providing an intermediate layer between the negative electrode and the lithium ion-conducting material of the protective layer suppresses the chemical reaction with the protective layer, depending on the material.

It may be provided that the first material is formed by a lithium ion-conducting material and the second material by a polymer, the lithium ion-conducting material being removed with the aid of chemical etching, laser ablation or ion beam etching. The lithium ion-conducting material may thus be manufactured in a variety of ways.

It may be furthermore provided that the spaces formed in the first material are filled with a monomer and/or a monomer-initiator mixture and/or an oligomer and/or an oligomer-initiator mixture, which are polymerizable, or the monomers and/or the oligomers include functionalized side chains, and/or a polymer which is fused into the spaces. The forming of the polymer may thus be initiated in a variety of ways using a variety of components, such as with the aid of heat or a temperature change or UV radiation.

According to one further embodiment, it is provided that the lithium ion-conducting material of the protective layer is formed of sulfidic, oxidic or phosphate-based glasses and/or ceramics. This ensures the best possible conductivity by the protective layer compared to known materials.

It may be furthermore provided that an intermediate layer (19) is situated between negative electrode (10) and the lithium ion-conducting material of protective layer (14) and/or between the electrolyte and the protective layer. Some of the lithium ion-conducting materials are not stable in direct contact with metallic electrodes, such as in particular lithium. Providing an intermediate layer between the negative electrode and the lithium ion-conducting material of the protective layer and/or between the protective layer and the electrolyte prevents direct contact of the protective layer with metallic lithium or electrolyte (FIG. 4f). Depending on the material, the chemical reaction with the protective layer is thus suppressed. To prevent impairing the function of the protective layer, the intermediate layer itself must be stable with respect to lithium or the electrolyte and have a sufficient lithium ion conductivity. The selection of the intermediate layer between electrolyte/protective layer, or between metallic Li/protective layer may thus differ based on the chemical composition.

The described embodiments and refinements may be arbitrarily combined with each other.

Further possible embodiments, refinements and implementations of the present invention also include not explicitly described combinations of features of the present invention which are described at the outset or thereafter with respect to the exemplary embodiments.

The accompanying drawings are intended to provide further understanding of the specific embodiments of the present invention. They illustrate specific embodiments and, in conjunction with the description, are used to explain principles and concepts of the present invention.

Other specific embodiments and many of the described advantages result with respect to the drawings. The elements shown in the drawings are not necessarily illustrated true to scale in relation to one another.

In the figures of the drawings, identical reference numerals denote identical or functionally equivalent elements, parts or components, unless indicated otherwise.

### BRIEF DESCRIPTION OF THE DRAWINGS

FIG. 1a shows a cross-sectional view of a protective layer of the electrochemical cell according to the present invention according to one specific embodiment of the present invention.

FIG. 1b shows a cross-sectional view of a protective layer of the electrochemical cell according to the present invention according to one further specific embodiment of the present invention.

FIG. 1c shows a cross-sectional view of a protective layer of the electrochemical cell according to the present invention according to one further specific embodiment of the present invention.

FIG. 2a shows a top view of the protective layer of the electrochemical cell according to the present invention according to one specific embodiment of the present invention.

FIG. 2b shows a top view of the protective layer of the electrochemical cell according to the present invention according to one further specific embodiment of the present invention.

FIG. 2c shows a top view of the protective layer of the electrochemical cell according to the present invention according to one further specific embodiment of the present invention.

FIG. 3a shows a method for manufacturing an electrochemical cell according to one specific embodiment of the present invention.

FIG. 3b shows a method for manufacturing an electrochemical cell according to one further specific embodiment of the present invention.

FIG. 3c shows a method for manufacturing an electrochemical cell according to one further specific embodiment of the present invention.

FIG. 4a shows a schematic view of an electrochemical cell according to one specific embodiment of the present invention.

FIG. 4b shows a schematic view of an electrochemical cell according to one further specific embodiment of the present invention.

FIG. 4c shows a schematic view of an electrochemical cell according to one further specific embodiment of the present invention.

FIG. 4d shows a schematic view of an electrochemical cell according to one further specific embodiment of the present invention.

FIG. 4e shows a schematic view of an electrochemical cell according to one further specific embodiment of the present invention. and

FIG. 4f shows a schematic view of an electrochemical cell according to one further specific embodiment of the present invention.

### DETAILED DESCRIPTION

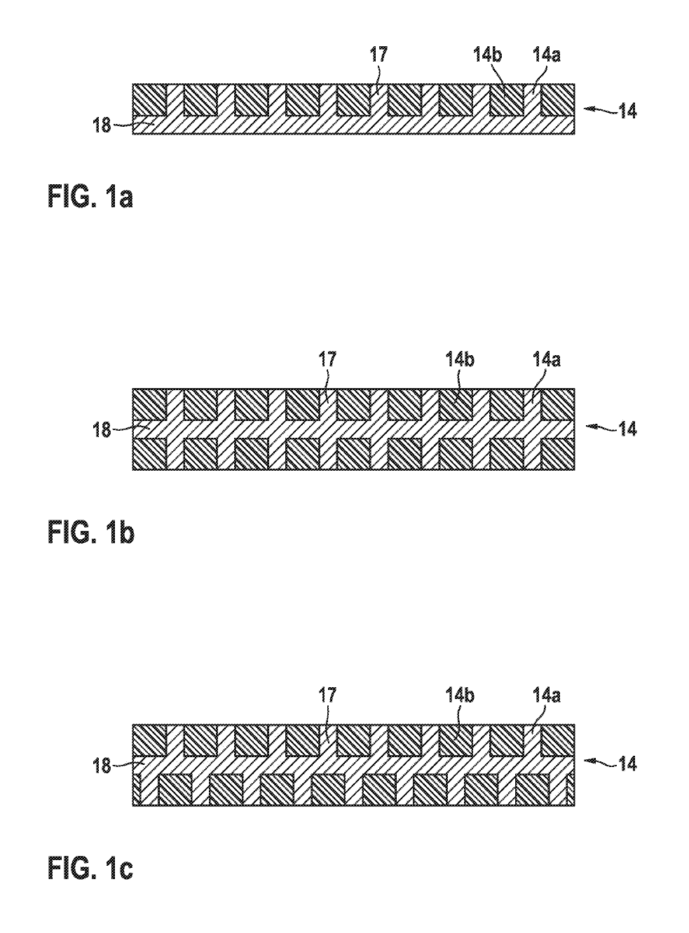

FIG. 1a shows a cross-sectional view of a protective layer of the electrochemical cell according to the present invention according to one specific embodiment of the present invention.

A protective layer 14 of an electrochemical cell (not shown in FIG. 1a) includes a first material 14a and a second material 14b according to the present specific embodiment. First material 14a is formed by a lithium ion-conducting material, and second material 14b is formed by a polymer. Lithium-ion conducting material 14a has a lattice-shaped structure, including a multitude of components 17 situated essentially perpendicularly to the negative electrode (not shown in FIG. 1a), and a component 18 situated essentially in parallel to the negative electrode (not shown in FIG. 1a). Spaces formed in lithium ion-conducting material 14a are filled with polymer 14b.

FIG. 1b shows a cross-sectional view of a protective layer of the electrochemical cell according to the present invention according to one further specific embodiment of the present invention.

Lithium ion-conducting material 14a according to the specific embodiment of FIG. 1b is situated in such a way that a component situated essentially in parallel to the negative electrode (not shown in FIG. 1b) is provided. Furthermore, a multitude of components 17 situated essentially perpendicularly to the negative electrode (not shown in FIG. 1b) are provided, the multitude of components 17 situated essentially perpendicularly to the negative electrode extending in each case above and beneath component 18 situated essentially in parallel to the negative electrode. The spaces formed in the lithium ion-conducting material are filled with polymer 14b. In contrast to the specific embodiment shown in FIG. 1a, protective layer 14 shown in FIG. 1b has a higher flexibility due to the higher fraction of polymer 14b.

FIG. 1c shows a cross-sectional view of a protective layer of the electrochemical cell according to the present invention according to one further specific embodiment of the present invention.

The specific embodiment shown in FIG. 1c differs from the specific embodiment according to FIG. 1b in that the multitude of components 17 situated essentially perpendicularly to the negative electrode (not shown in FIG. 1c) are situated offset from each other above and beneath component 18 situated essentially in parallel to the negative electrode. Alternatively, all possible intermediate stages in the degree of the offset between the representation according to FIG. 1b and FIG. 1c are conceivable.

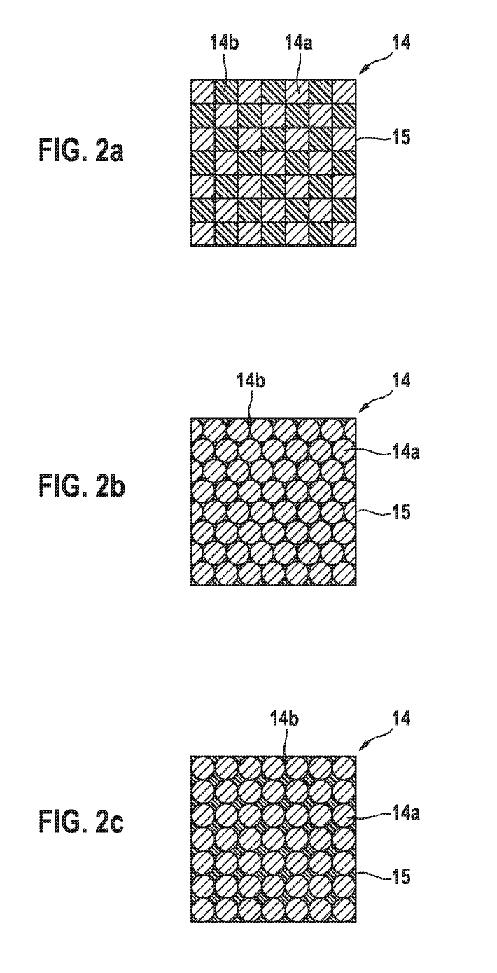

FIG. 2a shows a top view onto the protective layer of the electrochemical cell according to the present invention according to one specific embodiment of the present invention.

Protective layer 14, in particular conduction paths 15 provided in the protective layer, has a rectangular cross section according to the representation of FIG. 2a. The conduction paths may alternatively also have any arbitrary other cross section. Depending on the mixing ratio of conduction paths 15 and polymer fraction in protective layer 14, it is thus possible to vary the flexibility of protective layer 14. The higher the polymer fraction in protective layer 14, the higher is its flexibility. In the representation according to FIG. 2a, the lithium ion-conducting material and the polymer are situated in a recurring arrangement in a fixed pattern. Alternatively, the arrangement may also be completely indiscriminate and random. Conduction paths 15 have contact with respective adjoining conduction paths. Alternatively, the conduction paths may also be situated in such a way that these do not have contact with their neighbors. An embodiment without contact between the conduction paths in the direction perpendicular to the negative electrode is advantageous due to the assumed conduction in the direction of the electrode.

FIG. 2b shows a top view of the protective layer of the electrochemical cell according to the present invention according to one further specific embodiment of the present invention.

Conduction paths 15 shown in FIG. 2b have a round cross section. The conduction paths may alternatively also have any arbitrary other cross section. At the same thickness of the protective layer, the ion conductivity increases with an increasing ion-conducting fraction in the protective layer since the contact surface area with the metallic lithium increases. This specific embodiment thus offers a high lithium ion conductivity and low transition resistances due to the large fraction of contact surface area of the electrolyte/lithium ion conductor in the composite material and lithium ion conductor in the composite material/electrode.

FIG. 2c shows a top view onto the protective layer of the electrochemical cell according to the present invention according to one further specific embodiment of the present invention.

In the representation of FIG. 2c, conduction paths 15 also have a round cross section. The conduction paths may alternatively also have any arbitrary other cross section. In contrast to the specific embodiment shown in FIG. 2b, the polymer fraction is increased in the specific embodiment according to FIG. 2c.

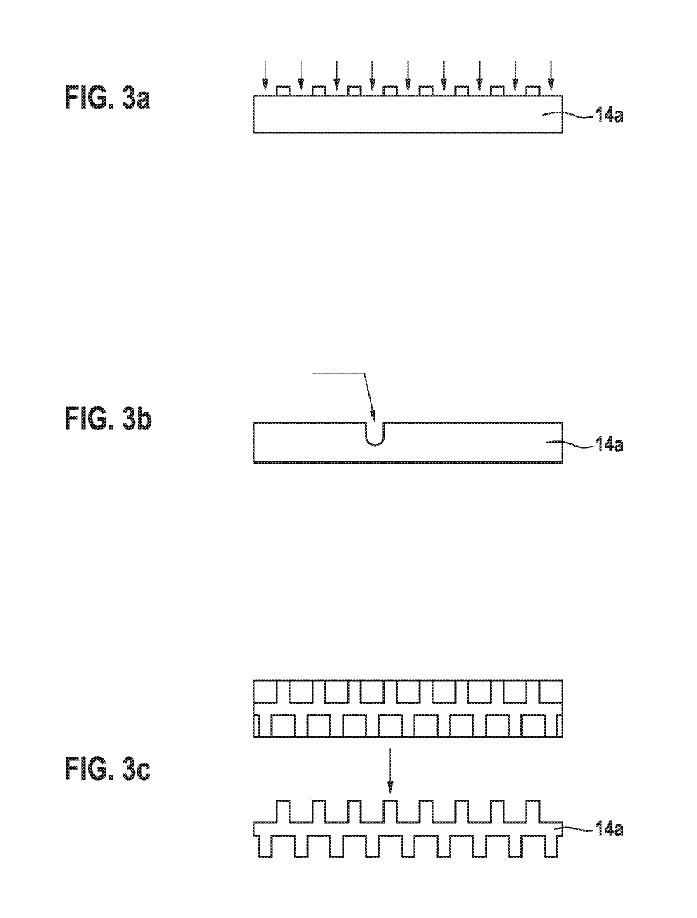

FIG. 3a shows a method for manufacturing an electrochemical cell according to one specific embodiment of the present invention.

The manufacture of protective layer 14, in particular of lithium ion-conducting material 14a, is carried out according to the specific embodiment of FIG. 3a with the aid of chemical etching.

FIG. 3b shows a method for manufacturing an electrochemical cell according to one further specific embodiment of the present invention.

According to the specific embodiment of FIG. 3b, lithium ion-conducting material 14a is manufactured with the aid of laser ablation.

FIG. 3c shows a method for manufacturing an electrochemical cell according to one further specific embodiment of the present invention.

Lithium ion-conducting material 14a is manufactured according to the representation of FIG. 3c with the aid of sintering. After the desired structure has been created, the polymer (not shown in FIG. 3c) is embedded. One option is to fill the resulting spaces with a monomer and/or a monomer-initiator mixture and/or substances, if necessary also with initiator added, containing functionalized side chains, which themselves are able to polymerize or are suitable for cross linking. The polymerization is initiated thereafter with the aid of a carrier, such as UV radiation, temperature, and the like. The monomer and oligomer units may include one or multiple of the following polymerizable functional groups, for example hydroxy, epoxy, isocyanate, isothiocyanate, chlorosilanes or halogen silanes, one or multiple C═C double bonds and/or triple bonds, either in the side chains, terminally, in the oligomer backbone and/or in a heterocycle, thiols, acrylates, anhydrides, lactones or lactams.

In addition to the above-described introduction of the inorganic polymer into the composite material by the polymerization of a corresponding chemical mixture in the preformed lithium ion-conducting substructure, it is also conceivable to press a finished polymer into the structure by heating it above its glass transition temperature and/or melting point. Alternatively, a previously cast negative of the structure shown in FIG. 3c may be manufactured and subsequently be integrated into the same. It is furthermore conceivable to embed a swellable polymer into the structure. Due to the action of the electrolyte (not shown in FIG. 3c) or its components and the resulting swelling, a good contact surface area then arises between the polymer and the lithium ion-conducting material shown in FIG. 3c.

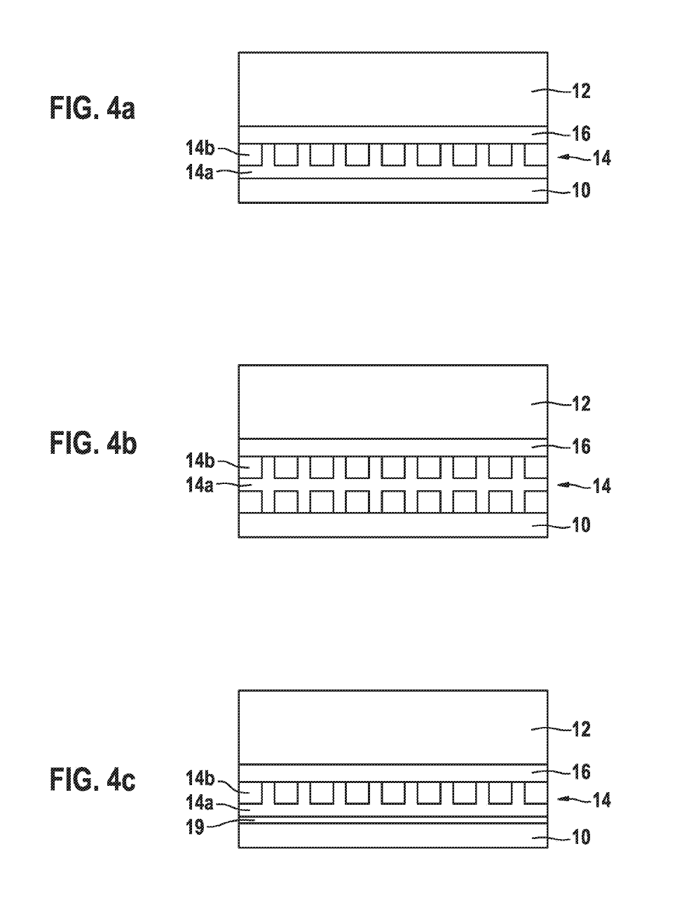

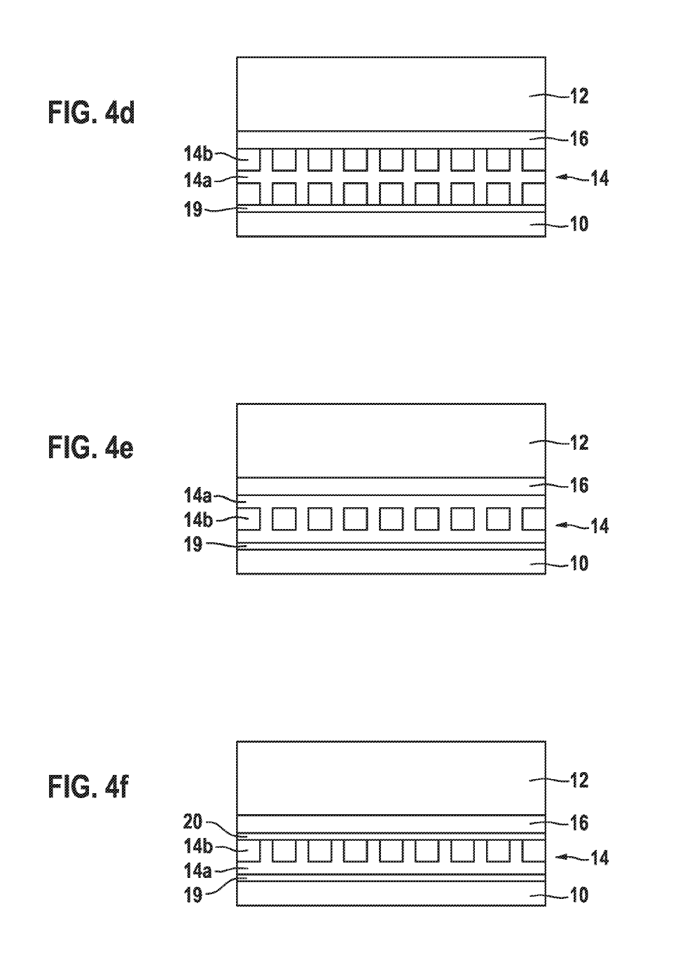

FIG. 4a shows a schematic view of an electrochemical cell according to one specific embodiment of the present invention.

The electrochemical cell shown in FIG. 4a includes a negative electrode 10, a positive electrode 12, a protective layer 14 situated on negative electrode 10, which separates negative electrode 10 from positive electrode 12, and an electrolyte 16, negative electrode 10 at least partially including metallic lithium. Protective layer 14 situated on negative electrode 10 is composed of a composite material, including a lithium ion-conducting material 14a and a polymer 14b. According to the specific embodiment of FIG. 4a, protective layer 14 has the structure shown in FIG. 1a. Lithium ion-conducting material 14a is formed of sulfidic glasses. Alternatively, lithium ion-conducting material 14a may also be formed of oxidic and phosphate-based glasses and/or ceramics, e.g., Li-containing garnets or LIPON. Polymer 14b is formed of polyethylene oxide (PEO).

FIG. 4b shows a schematic view of an electrochemical cell according to one further specific embodiment of the present invention.

In contrast to the specific embodiment shown in FIG. 4a, the specific embodiment shown in FIG. 4b includes the protective layer shown in FIG. 1b.

FIG. 4c shows a schematic view of an electrochemical cell according to one further specific embodiment of the present invention.

According to the specific embodiment of FIG. 4c, an intermediate layer 19 is situated between negative electrode 10 and lithium ion-conducting material 14a of protective layer 14. Intermediate layer 19 is useful, for example, when the lithium ion-conducting layer is made of LAGP, e.g., or in the case of some sulfidic glasses, since these are not stable in direct contact with metallic electrodes, such as in particular lithium. Intermediate layer 19 is a vapor-deposited Li-containing garnet layer or another lithium-stable, conducting layer.

FIG. 4d shows a schematic view of an electrochemical cell according to one further specific embodiment of the present invention.

Protective layer 14 used according to the specific embodiment of FIG. 4d has the structure of protective layer 14 shown in FIG. 1b. In addition, as is also shown in FIG. 4c, an intermediate layer 19 is situated between negative electrode 10 and lithium ion-conducting material 14a of protective layer 14.

FIG. 4e shows a schematic view of an electrochemical cell according to one further specific embodiment of the present invention.

According to the specific embodiment of FIG. 4e, protective layer 14 has a structure according to which two components are provided, which extend in parallel to each other and in parallel to negative electrode 10. Above-mentioned components of lithium ion-conducting material 14a of protective layer 14 which extend in parallel to negative electrode 10 are connected by a multitude of components extending essentially perpendicularly to negative electrode 10. In addition, an intermediate layer 19 is situated between negative electrode 10 and lithium ion-conducting material 14a of protective layer 14.

FIG. 4f shows a schematic view of an electrochemical cell according to one further specific embodiment of the present invention.

According to the specific embodiment of FIG. 4f, the utilized protective layer 14 has the structure shown in FIG. 1a. In addition, an intermediate layer 19 is situated between negative electrode 10 and lithium ion-conducting material 14a of protective layer 14. Moreover, a further intermediate layer 20 is situated between positive electrode 12 and lithium ion-conducting material 14a of protective layer 14. Depicted intermediate layer 19 or 20 serves to provide better contact between lithium ion-conducting material 14a and the particular electrode. The effect of a potentially increased internal resistance caused by the additional interface is compensated for by the improved contacting.

Although the present invention has been described above based on the exemplary embodiments, it is not limited thereto, but is modifiable in a variety of ways. The present invention may in particular be changed or modified in multiple ways without departing from the scope of the present invention.

For example, the lattice-shaped structure of lithium ion-conducting material 14a may be situated in any arbitrary form. Furthermore, providing an intermediate layer between negative electrode 10 and lithium ion-conducting material 14a of protective layer 14, or between positive electrode 12 and lithium ion-conducting material 14a of protective layer 14, is optional. Protective layer 14 may furthermore have the function of a separator.

1-10. (canceled)

11. An electrochemical cell, compfising:
a negative electrode;
a positive electrode;
a protective layer situated on the negative electrode, which separates the negative electrode from the positive electrode; and
an electrolyte;
wherein the negative electrode at least partially includes metallic lithium, and
wherein the protective layer situated on the negative electrode is formed of a composite material, including at least one first material and one second material.

12. The electrochemical cell of claim 11, wherein the first material is formed by a lithium ion-conducting material and the second material is formed by a polymer, the protective layer including conduction paths, which are formed by material channels of the lithium ion-conducting material, the conduction paths being formed continuously in the vertical direction of the protective layer.

13. The electrochemical cell of claim 12, wherein the lithium ion-conducting material has a lattice-shaped structure, including a multitude of components situated essentially perpendicularly to the negative electrode, which are connected by a parallel layer made of the same material, spaces formed in the lithium ion-conducting material being filled with polymer.

14. The electrochemical cell of claim 12, wherein the conduction paths each have a rectangular or round cross section.

15. The electrochemical cell of claim 12, wherein an intermediate layer is situated between the negative electrode and the lithium ion-conducting material of the protective layer.

16. A method for manufacturing an electrochemical cell, the method comprising:
providing a negative electrode, a positive electrode, a protective layer to be situated on the negative electrode, to separate the negative electrode from the positive electrode, and an electrolyte, the negative electrode at least partially including metallic lithium, and the protective layer to be situated on the negative electrode being formed of a composite material, including at least one first material and one second material;
removing material of the first material;
filling the second material into spaces formed in the first material to form the protective layer; and
situating the protective layer on the negative electrode of the electrochemical cell.

17. The method of claim 16, wherein the first material is formed by a lithium ion-conducting material and the second material is formed by a polymer, the lithium ion-conducting material being removed with one of chemical etching, laser ablation, and ion beam etching.

18. The method of claim 16, wherein the spaces formed in the first material are filled with at least one of a monomer, a monomer-initiator mixture, an oligomer, and an oligomer-initiator mixture, which are polymerizable to a polymer, wherein at least one of the following is satisfied: (i) one of the monomers and the oligomers include functionalized side chains, and (ii) the polymer is fused into the spaces.

19. The method of claim 17, wherein the lithium ion-conducting material of the protective layer is formed of one of sulfidic, oxidic, and phosphate-based materials, the materials being at least one of glasses and ceramics.

20. The method of claim 16, further comprising:
situating an intermediate layer at least one of: (i) between the negative electrode and the lithium ion-conducting material of the protective layer; and (ii) between the electrolyte and the protective layer,
